(19) United States
(12) Patent Application Publication
(10) Pub. No.: US 2020/0140209 A1
(43) Pub. Date: May 7, 2020

(54) Processing Device and Method for Processing Separated Packages

(71) Applicant: SIG Technology AG, Neuhausen am Rheinfall (CH)

(72) Inventor: Daniel Weber, Schaffhausen (CH)

(21) Appl. No.: 16/607,376

(22) PCT Filed: Apr. 23, 2018
(86) PCT No.: PCT/EP2018/060335

§ 371 Date: Oct. 23, 2019

(30) Foreign Application Priority Data
Apr. 27, 2017 (DE) 10 2017 109 126.2
Apr. 27, 2017 (EP) 17020178.4

(51) Int. Cl. B65G 47/84; B65B 61/24

(52) U.S. Cl. CPC B65G 47/846; B65G 47/29; B65B 61/24

(57) ABSTRACT

Described and depicted is a processing device for processing, preferably filled and scaled, packages, in particular cardboard composite packages, having a processing station for processing the packages, preferably for forming the packages and/or for applying additive packaging materials to these packages, having a transport device for supplying, in particular accumulated, packages along a supply path and for further transport of separated packages in the direction of the processing station along a relay path and having a separating device for separating the packages supplied via the transport device, wherein the separating device has a plurality of sliding means circulating respectively along a common, closed transport track and distributed along the transport track for moving the packages in an interlocking manner from the supply path to the relay path at least substantially transverse to the supply path and/or relay path in the region of the separating device. So that a reliable operation of the processing device can be achieved with at same time higher processing speeds, it is provided that the sliding means mounted on two rotary discs which are spaced apart from one another in the vertical direction and are rotatable about a respective axis of rotation, and in that the axes of rotation of the rotary discs are arranged parallel to one another and spaced horizontally apart from one another.

The invention relates to a processing device for processing, preferably filled and sealed, packages, in particular cardboard composite packages, having a processing station for processing the packages, preferably for forming the packages and/or for applying additive packaging materials to the packages, having a transport device for supplying, in particular accumulated, packages along a supply path and for further transport of separated packages in the direction of the processing station along a relay path and having a separating device for separating the packages supplied via the transport device, wherein the separating device has a plurality of sliding means circulating respectively along a common, closed transport track and distributed along the transport track for moving the packages in an interlocking manner from the supply path to the relay path at least substantially transverse to the supply path and/or relay path in the region of the separating device. The invention further relates to a method for processing, preferably filled and sealed, packages, in particular cardboard composite packages.

Processing devices for processing packages are known in different embodiments, wherein the packages are formed by the packaging and the packaged goods received therein. For example, bottles, tubular bags, cans, etc. may be possible packaging. The processing devices also serve primarily for the processing of already filled and sealed packages, on which for example additive packaging material, such as straws, which are also referred to as drinking straws, resealable spouts and/or opening elements, tear-off tabs, which are also referred to as pull tabs, labels or similar are to be applied. Alternatively or additionally, for certain packages the processing device can also be used for the forming of the packages, so that the packages assume a desired, in particular appealing, final form. The processing devices are then as required also designed as so-called form stations, in which pressing tools are used to “emboss” the desired form on the packages. Further processing steps are also conceivable.

The present packages are primarily composite packages, which are used as alternatives to, for example, bottles or cans. Corresponding packaging is mainly filled with the packaged goods and sealed in a so-called filling machine, which for cardboard composite packages are often also referred to as forming/filling/sealing machines based on their main functions, specifically forming the packaging, filling the packaging and sealing the packaging.

Possible packaged goods are in particular flowable, i.e. liquid or at least pasty and, as required, can also contain lumpy parts. Dry and granulated packaged goods are not excluded, but do not play a significant role in practice. Often, foodstuffs are received in the packages, such as drinks, in particular milk, juices, nectars, dairy products and soups. In the case of drinks, cardboard composite packages are also referred to as drinks carton composite packages.

Composite packages are formed from interconnected packaging materials which form a sheet-like layer structure, the so-called packaging laminate. Cardboard composite packages have a cardboard layer, which give the package stability and can serve as a carrier layer for the plastic layers arranged on both sides of the cardboard layer. Plastic layers serve as liquid barriers, for example. Thus, for example, the penetration of flowable products into the packaging laminate, in particular the cardboard layer, or even the leakage of flowable products is also avoided, as is the penetration of moisture from the outside. Furthermore, thermoplastic materials can be sealed to form firmly bonded sealing seams so as to form a packaging and seal the package. The packaging laminate may comprise further layers and packaging materials; for example an aluminium layer provides a barrier effect against gases and light. To be able to fold the sheet-like packaging laminate, i.e. to be able to fold it by machine, creases are often introduced into the packaging laminate which predefine the later fold lines. The folds form the package edges on the package and/or facilitate the shaping of the bottom and/or top of the package. Most packaging laminates are also printed with a decor.

The packaging laminate can be cut before forming the packaging, whereby so-called blanks are created. These may be further processed into so-called packaging casing blanks. For this purpose, the longitudinal edges are overlapped and sealed together to form a longitudinal sealing seam. A pipe-like casing or a so-called packaging casing blank or packaging sleeve is obtained in this way. Alternatively, the packaging laminate can be provided as continuous material, in particular as rolled goods, from which a packaging can be directly formed without first creating a blank.

From WO 93/02923 A1 a processing device and a corresponding method for applying additive packaging material in the form of spouts on filled and sealed packages are known. The packages are thus successively supplied via a transport belt of a transport device along a straight line supply path of a separating device and accumulated along the supply path in front of the separating device. The separating device comprises sliding means distributed along a closed transport track. While the sliding means circulate around the closed transport track, the sliding means successively press laterally against the accumulated and thus to-be-separated packages, whereby the packages are pushed transversely to the supply path of the packages on another transport belt of the transport device, which relays the separated packages along a straight-line relay path to a processing station of the processing device. In the processing station, the additive packaging materials are applied in succession in the form of spouts to the separated packages.

However, using corresponding processing devices, only limited processing speeds can be achieved, since otherwise a reliable operation cannot be guaranteed. This is due in particular to the requirements for package handling. If the conveying of the packages is not carried out as intended, for example because individual packages accidentally slip, the operation of the processing device is impaired, so that the processing device must be stopped if necessary. In addition, packages usually have a small footprint in relation to their height, which is why packages usually tend to tip over. If a package tips over, for example, during separating, this will regularly lead to a production stop. Furthermore, when handling packages, care must be taken to ensure that the decor and appearance of the packages are not damaged.

The object of the present is therefore to design and refine the processing device and the method of the type referred to at the outset and previously described in detail in such a way that a reliable operation of the operating device is possible with at the same time higher processing speeds.

This object is achieved with a processing device according to the preamble of claim 1, in that the sliding means are mounted on two rotary discs which are spaced apart from one another in the vertical direction and are rotatable about a respective axis of rotation, and in that the axes of rotation of the rotary discs are arranged parallel to one another and spaced horizontally apart from one another.

The mentioned object is also achieved according to claim 13 by a method for processing, preferably filled and sealed, packages, in particular cardboard composite packages,
in which packages to be separated, in particular accumulated, are supplied using a transport device along a supply path to a separating device and are transported onward by the separating device along a relay path in the direction of a processing station,
in which the packages are moved by the separating device with sliding means circulating in a closed transport track and distributed along the transport track, in an interlocking manner, from the supply path to the relay path and at least substantially transversely to the supply path and/or relay path in the region of the separating device,
in which two rotary discs spaced apart in the vertical direction and connected to the sliding means are rotated about mutually parallel and horizontally spaced axes of rotation, and
in which the separated packages are processed in a processing station, in particular formed or provided with additive package materials.

The arrangement of the sliding means on two rotary discs which are spaced apart from one another in the vertical direction and are rotatable about a respective axis of rotation such that the axes of rotation of the rotary discs are arranged parallel to one another and spaced horizontally apart from one another, facilitates a very precise guiding of the sliding means, even when the sliding means are moved very quickly, in order to ensure a high throughput of packages. In addition, the rotation of the rotary discs can be very accurately adapted to the movement of the transport device for relaying the packages so that, if necessary, a consistently guided transport of the packages is ensured to prevent disruptions to operation.

In this case, the sliding means can be arranged between the rotary discs, so that the sliding means can be quite rigid and/or resistant. This not only serves to ensure the longevity of the separating device, but also the permanently precise guidance of the sliding means along the circumferential transport track. The corresponding arrangement of the sliding means also makes it possible to push the packages quite far to the side on a rather short piece of the transport device, which may favour the separation, without requiring an excessive installation space. In addition, wear can be reduced, which reduces the need for maintenance.

Finally, packages can be separated very easily with a separating device and then separately relayed to a processing station. The advantages already discussed come into play in particular when it comes to a filled and sealed package, such as a cardboard composite package. These place particular demands on the packaging handling. The packages to be separated are supplied to the separating device using a transport device along a supply path, which supply path is rectilinear as required. The packages can already touch, seen in the transport direction, or be accumulated in front of the separating device. The separating device has sliding means which circulate along a closed transport track and therefore continuously. In order to achieve a uniform separation of the packages, it is advisable if the sliding means are distributed uniformly along the closed transport track. This can lead to the fact that the intervals between adjacent sliding means are each at least substantially constant. The circulation of the sliding means along the closed transport track is achieved simply and reliably by fixing the sliding means on two rotary discs. The rotary discs are oriented on the one hand in the vertical direction parallel to each other and offset in the horizontal direction to each other. Therefore, the axes of rotation of the rotary discs extend parallel to each other and offset in the horizontal direction.

The rotation of the rotary discs allows the sliding means to continuously circulate around a closed transport track. While the sliding means circulate along the transport track, the sliding means push the packages to be separated one after the other in an interlocking manner to the side and separate the corresponding packages thereby. The packages arrive from the supply path to a relay path along which the separated packages are relayed via the transport device, if necessary rectilinearly, to a processing station. The packages are thus accelerated less by the separating device in the transport direction, but rather moved in the region of the separating device transversely to the supply path and/or transversely to the relay path. Furthermore, it is sufficient if the packages are relayed by the transport device only in the direction of the processing station if it is ensured in another way that the packages reach the processing station. The transport of the separated packages is also carried out along the relay path by the same transport device, although not necessarily by the same transport means. In the processing station, the separated packages can then be processed in the desired manner, wherein in particular a forming of the packages, in particular the cardboard composite packages, or an application of additive packaging materials, preferably in the form of spouts or in the form of, in particular wrapped, straws is referred to.

For ease of understanding and to avoid unnecessary repetitions, the processing device and the method are described together in the following, without distinguishing in each case in detail between the processing device and the method. However, it will be apparent to the person skilled in the art, given the context, which feature is preferred with respect to the processing device and with respect to the method.

In a first particularly preferred embodiment of the processing device, the sliding means are distributed uniformly over the circumference of at least one rotary disc. This simplifies the operation of the processing device and allows a high throughput of packages, without fear of operational disruptions. Alternatively or additionally, the sliding means may be formed bend-proof, so that the lateral movement of the packages from the supply path to the relay path can be defined in the same way and reliably regardless of the type of packages. In order run the movement in a defined and reliably manner without this inadvertently leading to damage to the packages, it is advantageous to rotatably connect the sliding means with at least one rotary disc, in particular with both rotary discs.

To provide simpler equipment for the processing device but also to increase the reliability of the method, if necessary, only one rotary disc can be driven directly via a drive. This drive leads to a rotation of the corresponding rotary disc, which drives the other rotary disc forcibly and thus also leads to a rotation of the other rotary disc. The movement of the directly driven rotary disc can be transmitted to the other rotary disc for simplicity via the sliding means connecting the rotary discs.

For a uniform and also precisely defined operation of the processing device, it is also advisable if the sliding means are connected in an at least substantially uniform radius from the axis of rotation of at least one rotary disc thereto. For simplicity, the sliding means are also preferably connected with respect to each rotary disc at a constant interval from the respective axis of rotation with the corresponding rotary disc. Then, the movement can take place uniformly and independently of the angular position in which the rotary discs are located. It is particularly simple and expedient if the intervals between the axes of rotation and the sliding means are the same size with both rotary discs.

In order to save installation space or to be able to move the packages quite far with the sliding means, a rotary disc can be arranged in sections in the vertical direction above or below the package to be moved next by the separating device and/or just moved by the separating device. If the rotary disc is arranged in the vertical direction above the corresponding package, it is additionally possible, if necessary, by means of the rotary disc to prevent the package from tipping over during the separation, i.e. during the lateral movement by the sliding means, thus leading to operational disruptions. Alternatively or additionally, a rotary disc can be arranged horizontally next to the package to be moved next by the separating device and/or package just moved by the separating device. In this way, for example, obstruction of the package transport by means of the transport device can be avoided. This is in particular the case when the packages are transported standing on a transport means of the transport device to the separating device or from there to the processing station.

For engaging on the packages and movement of the packages in an interlocking manner from the supply path to the relay path, the sliding means respectively have at least one sliding surface. If the at least one sliding surface is overall large enough, when moving the packages the surface-specific forces acting on them are so small that damage to the packages can be safely avoided. If the sliding surfaces are also oriented parallel to one another, a gentle, flat fitting is achieved on the sides of the packages. So that, during the circulation around the closed transport track, the sliding surfaces do not have to be adjusted and each exactly oriented before engaging on the packages again, the sliding surfaces may be oriented parallel to one another by a suitable connection of the sliding means to the rotary discs, regardless of the angle of rotation of the rotary disc.

To ensure a defined package transport, the packages to be separated and/or the packages already separated can in the region of the separating device be guided laterally on the sides of the packages facing the sliding means by at least one guide surface . The at least one guide surface can thus be provided by at least one guide rail, a supply guide and/or a relay guide, wherein the supply guide and/or the relay guide themselves may in turn respectively comprise at least one guide rail. Thus, for example, it is achieved that the packages to be separated accumulate in succession along the corresponding, at least one guide rail and/or supply guide. Alternatively or additionally, it can be ensured that the separated packages are transported in the direction of the processing station in a defined manner along the at least one guide rail and/or the relay guide. So that the separation of the packages is not impaired by the sliding means, the at least one sliding surface of each sliding means can be provided such that the sliding surfaces when rotating about the axes of rotation of the rotary disc engage over and/or under the at least one guide surface of the at least one guide rail, the supply guide and/or the relay guide. In other words, the sliding surfaces are moved from the side of the guide horizontally beyond the guide surface of the associated guide in the direction of the packages to move the packages away from the guide surface of the respective guide rail and/or the supply guide and in the direction of the relay path and/or the relay guide.

In order to be able to achieve a particularly targeted and gentle movement of the packages, each sliding means can have at least two sliding surfaces spaced apart from one another such that when rotating the rotary discs about their axes of rotation at least one sliding surface repeatedly engages over the at least one guide surface of the at least one guide rail, the supply guide and/or the relay guide and at least one other sliding surface repeatedly engages under the at least one guide surface of the at least one guide rail, the supply guide and/or the relay guide. Thus, a sliding surface above the guide rail, the supply guide and/or the relay guide and a sliding surface of the same sliding means below the guide rail, the supply guide and/or the relay guide come into contact with the package to move the package laterally. Thus, if necessary, a tipping over of the packages when moving the same can be prevented.

Regardless of the configuration of the sliding surfaces, the separating device may have a movement guide for laterally guiding the packages during the movement of the packages by the sliding means. When moving, the packages are guided in a securer and a more targeted manner, i.e. not only by the sliding surfaces of the sliding means, but also by the at least one guide surface of the movement guide. When the movement guide transitions to a relay guide for guiding the packages along the relay path, the guidance of the packages in the processing device is further improved. It is conducive to a uniform transport of the packages if the transition of the movement guide to the transfer guide, in particular the transition of the guide surface of the movement guide to the guide surface of the relay guide is continuous.

For reasons of simplicity, the packages to be separated and/or the separated packages may be arranged on a transport means of the transport device for the transport of the packages along the supply path and/or the relay path. The transport means may therefore be a conveyor belt, for example. The packages can thus be transported gently and without a great deal of equipment requirements. The transport of the packages can be carried out as a result of frictional engagement between the transport means of the transport device. However, it is nevertheless or alternatively possible for a slip to form between the transport means and the packages standing thereon. As a result of the slip, the transport speeds of the packages differ from the transport speed of the transport means arranged underneath the packages. For the sake of simplicity and for a precisely defined transport of the packages, the packages can be decelerated, held and/or moved in an interlocking and/or frictionally engaging manner in the transport direction and, for example, thereby cause a slip between the packages and the transport means.

Alternatively or additionally, it is possible to provide a transport means extending laterally to the packages to be separated and/or of the separated packages for transporting the packages in the transport direction. This transport means can accomplish or assist the precise transport, for example to prevent the packages from tipping over. However, the lateral transport means may preferably also be provided for interlocking and/or frictionally engaged decelerating, holding and/or moving of the packages in relation to the transport speed of the transport means carrying the packages. In other words, the lateral transport means can define the transport speed, wherein the transport speed of the lateral transport means preferably corresponds to the transport speed of the packages, while the transport speed of the transport means on which the packages stand is faster or slower than the transport speed of the packages.

The reliability of the package handling with the separating device can be further increased if the sliding means have at least one stop surface for coming into contact with the respective package that is to be separated next. Thus, the package to be separated next can be guided, for example, by the sliding means separating the preceding pack, i.e. by coming into contact with the stop surface of this sliding means, i.e. until the package is separated or moved by the following sliding means. The contact of the next package to be separated with the stop surface of the package means separating or moving the preceding package can be used for an interlocking deceleration of the next packages to be separated to the transport speed of the transport means carrying the packages. The packages can be quickly guided along by means of a fast moving transport means, wherein the packages are decelerated or accumulated in that the respective front package comes into contact with the stop surface of a sliding means. As a result, the packages to be separated next are positioned respectively exactly for the separating or the lateral movement by the following sliding means.

In terms of equipment, it is simple if the transport means carrying the packages and/or the transport means provided laterally of the separated packages is a conveyor belt. In this case, the lateral transport means, for example, may comprise holding cams for coming into contact with a surface of the packages facing in the transport direction of the packages and/or against the transport direction. The holding cams can then accelerate or decelerate these packages by coming into interlocking contact with the corresponding surfaces of the packages, with respect to the transport means on which the packages stand. The packages then move at the transport speed of the holding cams and not at the, when required, differing transport speed of the transport means carrying the packages. In the case of a holding cam having transport means arranged laterally to the separated packages it is advantageous if this transport means is also arranged in sections laterally to the packages still to be separated along the supply path. Thus, the separation of the packages can be carried out uniformly and reliably. Since, in particular, the package to be separated next should be precisely aligned with respect to the separating device, it may be sufficient if the lateral transport means comprising the holding cam extends at least laterally next to the package to be separated next.

In a first particularly preferred embodiment of the method, the next package to be separated rests against at least one stop surface of a sliding means, wherein the stop surface is then preferably provided by the respective sliding means, which moves the preceding package. Irrespective of this, the package respectively next to be separated may also stand on a transport means and be moved in frictional engagement by the transport means, preferably while forming a slip, against the stop surface. This can be achieved in such a way that the transport means carrying the next package to be separated moves faster in the transport direction than the sliding means located in front of the corresponding package. The stop surface of this sliding means thus decelerates the package in relation to the transport means carrying the package.

Carrying out the method is particularly simple if the package resting respectively against the stop surface of a sliding means is moved by the respective subsequent sliding means from the supply path to the relay path and thus separated. Thus, the preceding sliding means in the end positions the next package for moving with the following sliding means, which increases the functionality of the sliding means.

For the sake of simplicity, the packages can be supplied standing on a transport means, in particular a conveyor belt, along the supply path of the separating device and relayed standing on the same transport means along the relay path in the direction of the processing station. Thus, the number of required transport means and therefore the amount of equipment can be reduced.

Alternatively or additionally, the separated packages can be moved further in an interlocking manner by a holding cam of a transport means arranged laterally to the separated packages, and preferably at the transport speed of the respectively associated holding cam. In addition, it is advantageous if the separated packages, during the interlocking further transporting of the packages, stand on a transport means moving slower than the respective holding cam. Then the transport speed is defined by the holding cam but the package is gently pulled over a transport means moving in the same direction.

The separated packages may also, during the interlocking further transporting of the packages, stand on a transport means moving in the transport direction of the packages faster than the packages. The packages can then be pressed respectively against a holding cam of a transport means extending laterally to the separated packages and moving in the transport direction of the packages, wherein preferably a slip is formed between the packages and the transport means carrying the packages. Thus, it is ensured that the packages always have the transport speed of the holding cams, without the holding cams having to pull the packages in the transport direction, which may lead to damage to the packages.

The packages can alternatively or additionally also be guided laterally along at least one supply guide, guided along a lateral movement guide during the separation and/or guided along a lateral relay guide after the separation so as to guide the packages in the respectively desired direction during transport. The movement of the packages can then be carried out via sliding surfaces of the sliding means, which for the movement of the packages repeatedly, in particular respectively once for each rotation, engage in the horizontal direction over at least one guide surface of the at least one guide rail, the at least one supply guide and/or the at least one relay guide and push against the packages, and push it so far that the sliding surfaces move the packages to the side. Thus, the at least one sliding surface of the at least one sliding means can be arranged, seen in the vertical direction, over the respective guide and/or under the respective guide.

The invention is explained in greater detail below by means of a drawing merely depicting an exemplary embodiment, wherein:

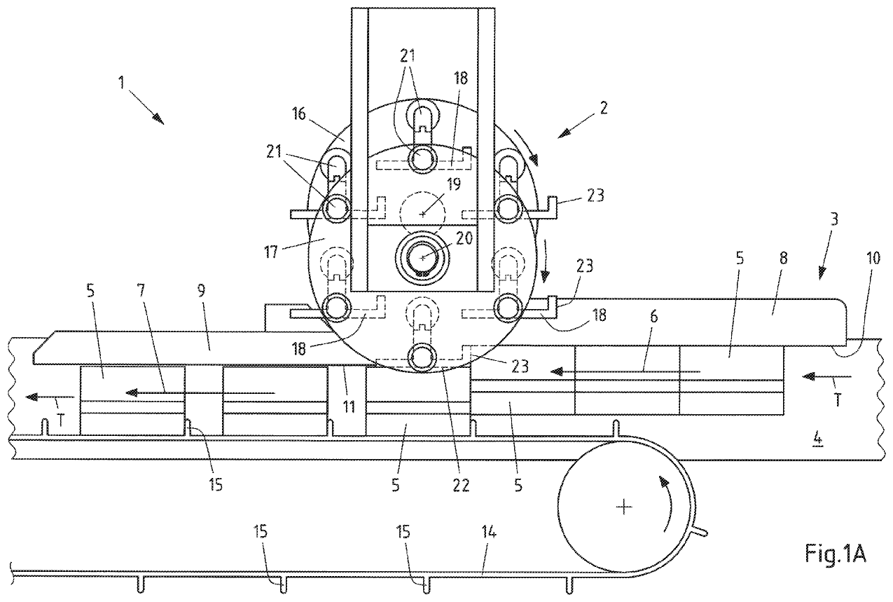

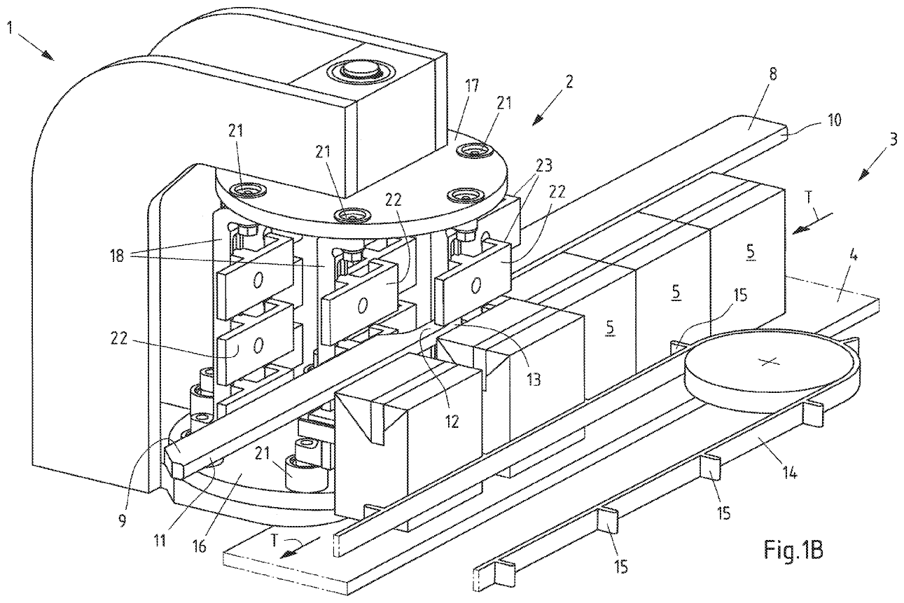

FIGS. 1A-B show a first processing device according to the invention in the region of a separating device in a schematic top view and a schematic perspective view,

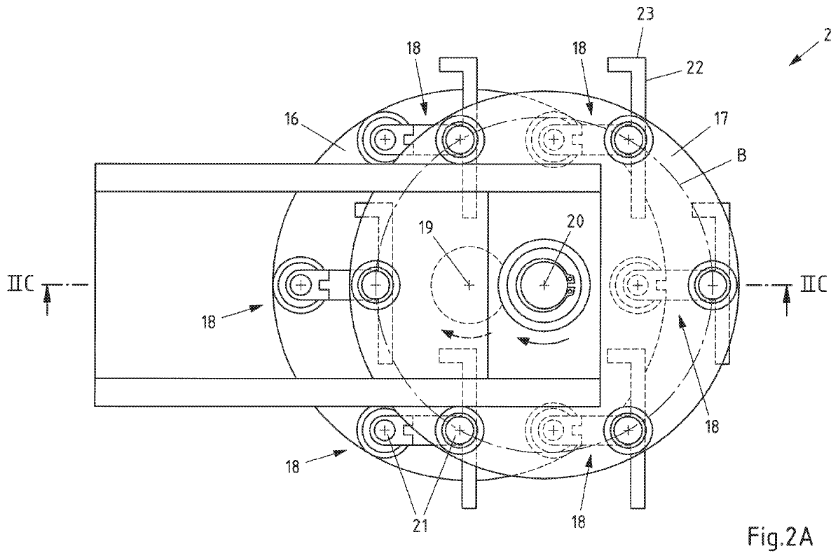

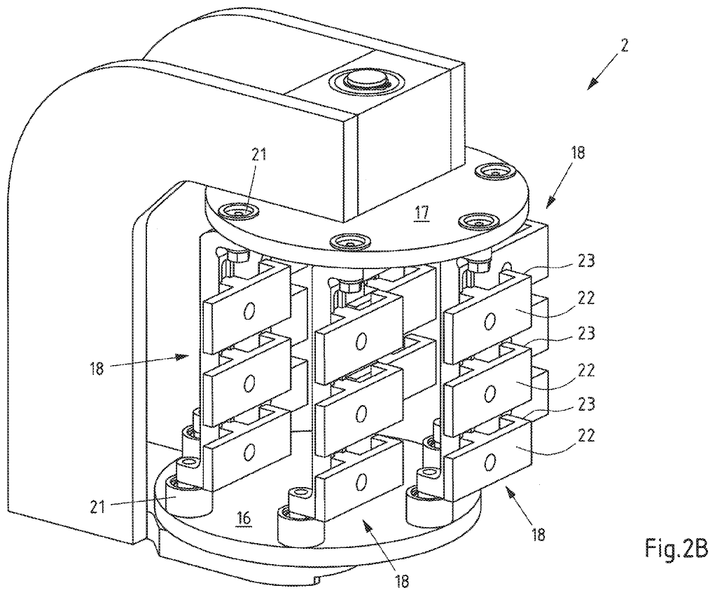

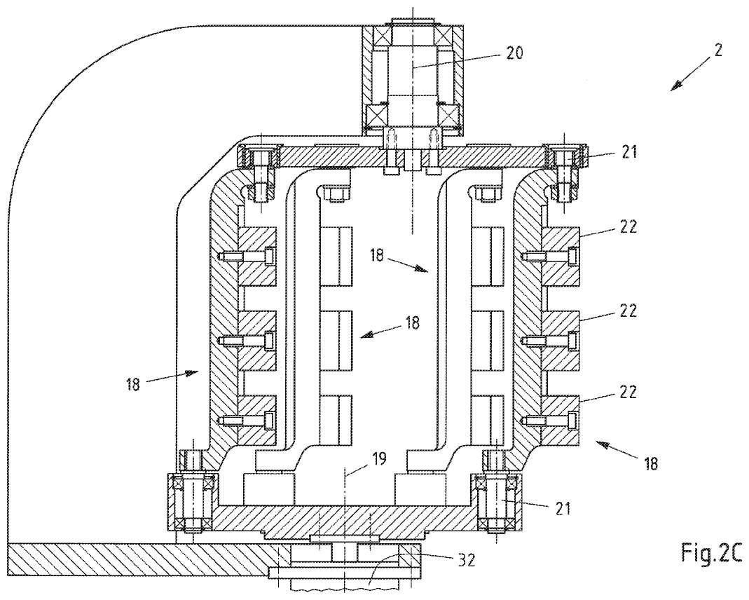

FIGS. 2A-C show the separating device from FIGS. 1A-B in a schematic top view, a schematic perspective view and a schematic sectional view, and

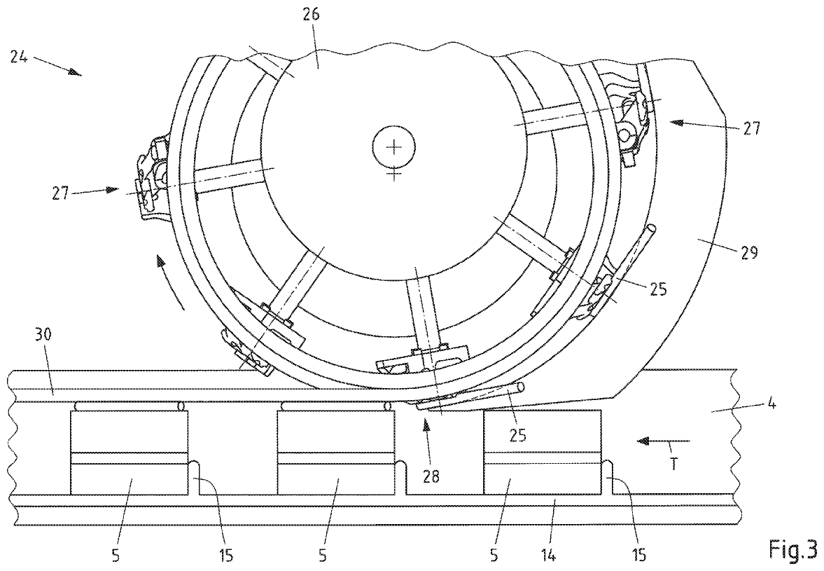

FIG. 3 shows the processing device according to FIGS. 1A-B in the region of a processing station in a schematic top view,

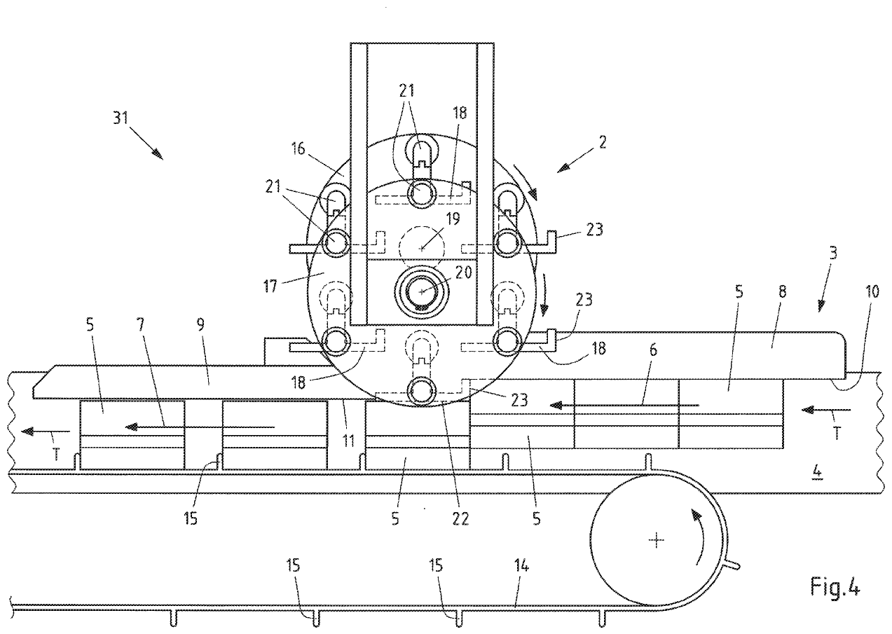

FIG. 4 shows a second processing station according to the invention in the region of a separating device in a schematic top view.

FIGS. 1A-B show a processing device 1 in the region of a separating device 2 in a schematic top view and a schematic perspective view. The processing device 1 has a transport device 3 which comprises transport means 4, for example in the form of a conveyor belt, moving in a transport direction T, on which packages 5 are conveyed in a standing position. The corresponding transport means 4 of the transport device 3 initially guides the packages 5 along a supply path 6, here designed as a straight line, toward the separating device 2. After the separation of the packages 5, the same transport means 4 of the transport device 3 transports the separated packages 5 which are still standing on the transport means 4 further along a relay path 7 which is also rectilinear here. In the depicted and insofar preferred processing device 1, the supply path 6 and the relay path 7 are oriented parallel to one another and spaced apart from one another in the horizontal direction.

On the sides of the supply path 6 and the relay path 7 facing the separating device 2, a supply guide 8 and a relay device 9 are provided which respectively provide guide surfaces 10, 11 for guiding the packages 5 transported along the supply guide 8 and the relay guide 9 along the supply path 6 and the relay path 7. Thus, the guide surfaces 10, 11 of the supply guide 8 and the relay guide 9 are also offset parallel to one another, as is the case for the supply path 6 and the relay path 7. In addition, in the depicted and insofar preferred processing device 1, a movement guide 12 is provided between the supply guide 8 and the relay guide 9 which serves to guide the packages 5 during separation, i.e. when moving from the supply path 6 to the relay path 7. Thus, the packages 5 can slide along a guide surface 13 of the movement guide 12 which continuously transitions to the guide surface 11 of the relay guide 9.

While the packages 5 are brought along the supply path 6 exclusively by the transport means 4 carrying the packages 5, the packages 5 remain standing on the transport means 5 after separation. However, the transport speed of the packages 5 is determined by a further transport means 14 arranged laterally to the packages 5, which may preferably be a conveyor belt. The transport means 14 comprises holding cams 15 which rest in an interlocking manner on the sides of the packages 5 facing away from the transport direction T. The holding cams 15 move in the transport direction faster than the transport means 4 carrying the packages 5. Thus, a slip is formed between the packages 5 and the transport means 4 carrying same and the holding cams 15 move the packages 5 over the transport means 4. Thus, the preferably constant interval of the holding cams 15 defines the interval of the separated and relayed packages 5.

The separating device 2 depicted separately in FIGS. 2A-C comprises two rotary discs 16, 17 arranged parallel to one another which are connected by means of a series of sliding means 18 uniformly distributed over the circumference of the rotary discs 16, 17. The sliding means 18 are thus rotatably and continuously fixed at the same interval from the axis of rotation 19, 20 of the respective rotary discs 16, 17 on the rotary discs 16, 17. The rotary discs 16, 17 are offset from one another in the horizontal direction like their axes of rotation 19, 20, but are oriented in parallel to one another. The connections 21 of each sliding means 18 with the two rotary discs 16, 17 are also spaced apart in the same way as the axes of rotation 19, 20 of the rotary discs 16, 17. When the rotary discs 16, 17 rotate, the sliding means 18 circulate continuously along a closed transport track B. By connecting the rotary discs 16, 17 via the sliding means 18, it is sufficient to drive one rotary disc 16 via a drive 32, in this case the lower rotary disc 16 to set both rotary discs 16, 17 in rotation about their axes of rotation 19, 20 according to the arrows shown. In the depicted and insofar preferred separating device 2, both rotary discs 16, 17 rotate at the same speed. In addition, the sliding means 18 remain oriented in the same way in the direction of the packages 5 during the rotation of the rotary discs 16, 17. The sliding means 18 respectively comprise a plurality of sliding surfaces 22 spaced apart form one another in the vertical direction which rest laterally on the packages 5 for separation provided that the packages 5 have a sufficient height. These sliding surfaces 18 are oriented in each angular position of the rotary discs 16, 17 parallel to the packages 5 or to the supply path 6 and/or to the relay path 7. Furthermore, the sliding means 18 are provided with stop surfaces 23 which are oriented at least substantially at right angles to the sliding surfaces 22, but do not have to be.

The sliding surfaces 22 are either arranged above or below the supply guide 8 and the relay guide 9 formed as guide rails, as shown in FIGS. 1A-B. Generally, the supply guide 8 and the relay guide 9 may also comprise a plurality of guide rails arranged one above the other so that the sliding surfaces 22 would then preferably be arranged above or below such a guide rail. In other words, each sliding surface 22 can be arranged above or below a guide surface 10, 11 of the supply guide 8 and/or the relay guide 9. The sliding surfaces 22 of the sliding means 18 are guided forward on the side of the guide surfaces 10, 11 facing away from the packages 5 and are pressed beyond the guide surfaces 10, 11 against the packages 5, wherein the packages 5, like the sliding surfaces 22, move away in the horizontal direction from the guide surfaces 10, 11 in the direction of the side of the packages 5 facing away from the separating device 2. Thus, the separation of the packages 5 is carried out, after which the corresponding sliding surfaces 22 of the sliding means 18 are moved back in the direction of the separating device 2 behind the guide surfaces 10, 11.

The packages 5 to be separated are in the meantime accumulated along a supply path 6 by the respectively front and therefore next-to-be-separated package 5 resting against stop surfaces 23 of the sliding means 18, which causes the separation of the preceding package 5 by means of the movement of the package 5. The package 5 to be separated next then comes into contact with the sliding surfaces 22 of the following sliding means 18, whereby the separation of this package 5 is brought about, wherein the following package 5 then comes into contact with the stop surface 23, to accumulate the packages 5 still to be separated and to position the next package 5 to be separated for separation with the following sliding means 18.

FIG. 3 shows the processing device 1 according to FIGS. 1A-B in the region of a processing station 24 in a schematic top view. The processing station 24 serves to apply additive packaging materials 25 in the form of straws to the sides of the packages 5 previously separated by the separating device 2. The packages 5 are thus transported along the relay path 7 past the processing station 24 by means of the lateral transport means 14 comprising holding cams 15. The packages 5 thus pass a rotating application wheel 26 on which circulating applicators 27 are provided which carry the additive packaging materials 25 to the packages 5 and apply the additive packaging materials 25 to the packages 5 in an application position 28. The packages 5 can be provided with adhesive for this purpose in advance. During the transportation of the additive packaging material 25 in the direction of the packages 5, the additive packaging materials 25 are moved along an additive packaging material guide 29, which prevents the additive packaging material 25 from falling off of the applicators 27. After the application of the additive packaging material 25 to the packages 5, the additive packaging material 25 is fixed to the packages 5 by means of a continuously circulating belt 30 until the adhesive has set.

An alternative processing device 31 is shown in FIG. 4 in the region of a separating device 2 which is similar to the previously described processing device 1. Therefore, the same components are provided with the same reference signs. However, one substantial difference is that the transport means 4, on which the packages 5 stand, moves faster than the transport means 14 arranged laterally to the packages 5. However, the transport speed of the packages 5 is limited by the transport speed of the holding cams 15 of the transport means 14 arranged laterally to the packages 5 against which the lower transport means 4 presses the packages 5. Due to the difference in relation to the transport speeds of the two transport means 4, 14, a slip is formed between the lower transport means 4 and the packages 5 standing on top of them.

The depicted and insofar preferred packages 5 are cardboard composite packages, in particular drinks carton composite packages. The associated packagings are formed from a flat, layer-shaped packaging laminate which has been formed into a closed package by folding and firmly bonded sealing seams. The packaging here is filled with a flowable foodstuff, in particular a drink, and closed by sealing the packaging laminate. The packaging laminate here comprises a cardboard layer and outer plastic layers made of a thermoplastic material.

### LIST OF REFERENCE SIGNS

1 Processing device
2 Separating device
3 Transport device
4 Transport means
5 Packages
6 Supply path
7 Relay path
8 Supply guide
9 Relay guide
10, 11 Guide surfaces
12 Movement guide
13 Guide surface
14 Transport means
15 Holding cam
16, 17 Rotary disc
18 Sliding means
19, 20 Axis of rotation
21 Connection
22 Sliding surfaces
23 Stop surfaces
24 Processing station
25 Additive packaging material
26 Applicator wheel
27 Applicator
28 Application position
29 Additive packaging material guide
30 Belt
31 Processing device

1. A processing device for processing, preferably filled and sealed, packages, in particular cardboard composite packages, having a processing station for processing the packages, preferably for forming the packages and/or for applying additive packaging materials to the packages, having a transport device for supplying, in particular accumulated, packages along a supply path and for further transport of separated packages in the direction of the processing station along a relay path and having a separating device for separating the packages supplied via the transport device, wherein the separating device has a plurality of sliding means circulating respectively along a common, closed transport track and distributed along the transport track for moving the packages in an interlocking manner from the supply path to the relay path at least substantially transverse to the supply path and/or relay path in the region of the separating device, and wherein
the sliding means are mounted on two rotary discs which are spaced apart from one another in the vertical direction and are rotatable about a respective axis of rotation, and in that the axes of rotation of the rotary discs are arranged parallel to one another and spaced horizontally apart from one another.
characterised in that the sliding means are arranged between the rotary discs.

2. The device according to claim 1,
characterised in that
the sliding means is distributed uniformly over the circumference of at least of rotary disc, designed so as to be bend-proof and/or rotatably connected to at least one rotary disc and/or in that one rotary disc is driven via a drive and the other rotary disc via the first rotary disc and the sliding means connecting the two rotary discs.

3. The device according to claim 1,
characterised in that
the sliding means are connected to the rotary disc in an at least substantially uniform radius from the axis of rotation of a rotary disc, and in that, preferably, the sliding means are connected to the rotary discs in an at least substantially complete radius from the respective axes of rotation of the rotary discs.

4. The device according to claim 1,
characterised in that
a rotary disc is arranged in sections in the vertical direction above or below the package to be moved next by the separating device or the package just moved by the separating device, and/or in that a rotary disc is arranged horizontally next to the package to be moved next by the separating device or the package just moved by the separating device.

5. The device according to claim 1,
characterised in that
the sliding means respectively comprise at least one sliding surface for moving the packages in an interlocking manner from the supply path to the relay path, and in that, preferably, the sliding surfaces are oriented parallel to one another, preferably regardless of the angle of rotation of the rotary discs.

6. The device according to claim 1,
characterised in that
the packages to be separated and/or the separated packages are guided in the region of the separating device laterally on the sides of the packages facing the sliding means by at least one guide surface of at least one supply guide and/or relay guide and in that, preferably, at least one sliding surface of each sliding means is provided so that when rotating about the axes of rotation of the rotary discs, the sliding surfaces engage over and/or under the at least one guide surface of the at least one guide rail, supply guide and/or relay guide so as to move the packages.

7. The device according to claim 6,
characterised in that
each sliding means has at least two sliding surfaces spaced apart from one another such that when rotating the rotary discs about their axes of rotation at least one sliding surface for moving the packages repeatedly engages over the at least one guide surface of the at least one guide rail and/or relay guide, and at least one other sliding surface repeatedly engages under the at least one guide surface of the at least one guide rail, supply guide and/or relay guide.

8. The device according to claim 1,
characterised in that
the separating device comprises a movement guide for laterally guiding the packages during the movement of the packages by the sliding means, and in that, preferably, the movement guide, preferably continuously, transitions to a relay guide for guiding the packages along the relay path.

9. The device according to claim 1,
characterised in that
the packages to be separated and/or the separated packages stand on a transport means for the transport of the packages along the supply path and/or the relay path, and in that, preferably, the packages are decelerated, held and/or moved in an interlocking and/or frictionally engaged manner in the transport direction while forming a slip between the packages and the at least one transport means.

10. The device according to claim 1,
characterised in that
a transport means extending laterally to the separated packages is provided for transporting the packages in the transport direction and, preferably for decelerating, holding and/or moving the packages in an interlocking and/or frictionally engaged manner in relation to the transport speed of the transport means carrying the packages.

11. The device according to claim 1,
characterised in that
the sliding means comprise at least one stop surface for coming into contact with the respective next package to be separated, and in that, preferably, the stop surface is designed for decelerating the packages to be separated in an interlocking manner in relation to the transport speed of the transport means carrying the packages.

12. The device according to claim 9,
characterised in that
the transport means carrying the packages is a conveyor belt and/or in that the transport means provided laterally to the separated packages is a conveyor belt preferably comprising holding cams for contact of a surface of the packages facing the transport direction of the packages and/or opposite the transport direction, and in that, preferably, the conveyor belt comprising holding cams extends in sections laterally to the packages to be separated along the supply path, preferably at least laterally next to the package to be separated next.

13. A method for processing, preferably filled and sealed, packages, in particular cardboard composite packages,
in which packages to be separated, in particular accumulated, are supplied using a transport device along a supply path to a separating device and are further transported from the separating device along a relay path in the direction of a processing station,
in which the packages are moved in the separating device with sliding means circulating in a closed transport track and distributed along the transport track, in an interlocking manner, from the supply path to the relay path and at least substantially transversely to the supply path and/or relay path in the region of the separating device,
in which two rotary discs spaced apart in the vertical direction and connected to the sliding means are rotated about mutually parallel and horizontally spaced axes of rotation,
in which the sliding means circulate between the rotary discs, and
in which the separated packages are processed in a processing station, in particular formed or provided with additive package materials.

14. The method according to claim 13,
in which the package to be separated next respectively rests against at least one stop surface of the sliding means, and
in which, preferably, the package to be separated next respectively stands on a transport means and is moved against the stop surface by the transport means in a frictionally engaged manner, preferably while forming a slip.

15. The method according to claim 14,
in which the package respectively resting against the stop surface of a sliding means is moved by the following sliding means from the supply path to the relay path.

16. The method according to claim 13,
in which the separated packages are moved in an interlocking manner by a holding cam of a transport means arranged laterally to the separated packages, and
in which, preferably, the separated packages, during the interlocking further transporting of the packages, stand on a transport means moving slower than the respective holding cam.

17. The method according to claim 13,
in which the separated packages stand on a transport means moving in the transport direction of the packages during the interlocking further transporting of the packages and preferably while forming a slip are thereby respectively pressed against a holding cam of a transport means extending laterally to the separated packages and moving in the transport direction of the packages.

18. The method according to claim 13,
in which the packages to be separated are guided laterally along at least one supply guide, the packages are guided along a lateral movement guide during the separation and/or the separated packages are guided along a lateral relay guide, and
in which, preferably, sliding surfaces of the sliding means for moving the packages repeatedly engage over at least one guide surface of the at least one supply guide and/or relay guide and push against the packages and/or engage under at least one guide surface of the at least one guide rail, supply guide and/or relay guide and push against the packages.
